(19) United States
(12) Patent Application Publication
(10) Pub. No.: US 2012/0100868 A1
(43) Pub. Date: Apr. 26, 2012

(54) METHOD AND APPARATUS FOR SEARCHING FOR BLUETOOTH DEVICE IN PORTABLE TERMINAL

(75) Inventors: Joong-Hyo KIM, Gyeongsangbuk-do (KR); Don-Gyo JUN, Gyeongsangbuk-do (KR)

(73) Assignee: SAMSUNG ELECTRONICS CO., LTD., Gyeonggi-Do (KR)

(21) Appl. No.: 13/277,572

(22) Filed: Oct. 20, 2011

(30) Foreign Application Priority Data
Oct. 20, 2010 (KR) 10-2010-0102351

(51) Int. Cl. H04W 4/02; H04W 24/00

(52) U.S. Cl. 455/456.1

(57) ABSTRACT

The present disclosure relates to a method and an apparatus for searching for a Bluetooth device in a portable terminal. The method includes: broadcasting an inquiry signal and then searching for Bluetooth devices located around the portable terminal, when a request for searching for a Bluetooth device is input, after acquiring location information and bearing information on the portable terminal; requesting the searched Bluetooth devices for identification information, and then acquiring the identification information; determining whether location information on each of the searched Bluetooth devices is packed in the identification information acquired from the searched Bluetooth devices; and calculating a relative location based on the acquired location information and bearing information and then displaying the calculated relative location.

### CLAIM OF PRIORITY

This application claims priority under 35 U.S.C. §119 to a Korean Patent Application entitled “Method and Apparatus for Searching for Bluetooth Device in Portable Terminal” filed in the Korean Intellectual Property Office on Oct. 20, 2010 and assigned Serial No. 10-2010-0102351, the contents of which are incorporated herein by reference.

### BACKGROUND OF THE INVENTION

1. Field of the Invention

The present invention relates to a method and an apparatus for searching for a Bluetooth device in a portable terminal.

2. Description of the Related Art

Bluetooth is a representative scheme used in a wireless devices for short-range communication, and enables the communication of voice and data between terminals, with low cost and low electric power.

A Bluetooth device sets a frequency hopping sequence and then broadcasts an inquiry signal, in order to search for other Bluetooth devices located nearby. In response to the inquiry signal, each surrounding Bluetooth devices transmits a response message to establish a connection.

FIG. 1 is an illustrative view of searching a Bluetooth device by a conventional portable terminal. As illustrated in FIG. 1, a mobile device 100 attempts to search randomly for Bluetooth devices 110, 120 and 130 located in a close vicinity in a simple list form or in a GUI (Graphical User Interface) form. Therefore, there has been a problem in that that only the approximate locations of the Bluetooth devices 110, 120 and 130 can be obtained whereas the actual exact locations of them cannot be ascertained.

### SUMMARY OF THE INVENTION

Accordingly, the present invention has been made to solve the above-mentioned problems occurring in the prior art, and the present invention provides a method and an apparatus for searching for a Bluetooth device in a portable terminal, in which when receiving a request for searching for a Bluetooth device, the portable terminal capable of Bluetooth communication acquires location information on Bluetooth devices located nearby, calculates relative locations of the Bluetooth devices with the portable terminal, which has requested the Bluetooth communication, as the reference, and then displays the calculated relative locations of the Bluetooth devices through a GUI, so that a user can intuitively ascertain the actual locations of the Bluetooth devices which are distributedly within a short distance of each other.

In accordance with an aspect of the present invention, a method for searching for a Bluetooth device in a portable terminal includes: broadcasting an inquiry signal and searching for Bluetooth devices located around the portable terminal in response to a request for searching for a Bluetooth device is input, after acquiring location information and bearing information on the portable terminal; requesting the searched Bluetooth devices for identification information, and then acquiring the identification information; determining whether location information on each of the searched Bluetooth devices is packed in the identification information acquired from the searched Bluetooth devices; and calculating a relative location based on the acquired location information and bearing information and then displaying the calculated relative location, when the location information on each of the searched Bluetooth devices is packed in the identification information acquired from the searched Bluetooth devices.

In accordance with another aspect of the present invention, an apparatus for searching for a Bluetooth device in a portable terminal includes: a Bluetooth communication unit for transmitting/receiving signals for acquiring identification information on at least one Bluetooth device capable of Bluetooth communication, which is located around the portable terminal, through predetermined channels; a location/bearing acquirer for acquiring location information and bearing information; a location calculator for calculating location information and a relative location of a device, which is located around the portable terminal and has been input, based on the location information and the bearing information acquired by the location/bearing acquirer; and a controller for broadcasting an inquiry signal and then searching for Bluetooth devices located around the portable terminal, requesting the searched Bluetooth devices for identification information and then acquiring the identification information, determining whether location information is packed in the acquired identification information, and calculating a relative location based on the acquired location information and bearing information and then displaying the calculated relative location, when the location information is packed in the acquired identification information.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is an illustrative view showing a screen image related to searching for a Bluetooth device by a conventional portable terminal;

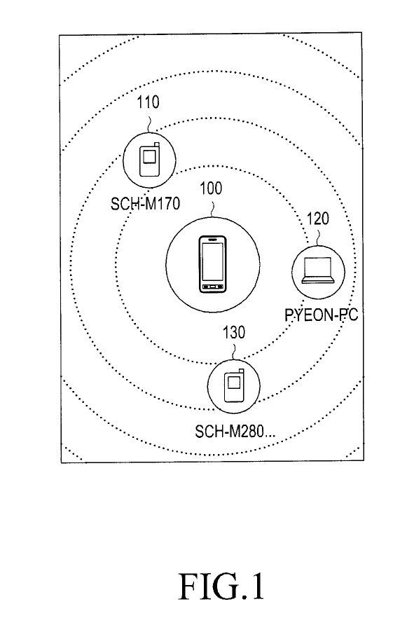

FIG. 2 is a flowchart showing a method for searching for a Bluetooth device in a portable terminal according to an embodiment of the present invention;

FIG. 3 is a flowchart showing an operation performed by a Bluetooth device located around a portable terminal in searching for a Bluetooth device by the portable terminal according to an embodiment of the present invention;

FIG. 4 is a block diagram illustrating the configuration of an apparatus for searching for a Bluetooth device in a portable terminal according to an embodiment of the present invention; and

FIGS. 5A, 5B and 5C are illustrative views showing screen images related to searching for a peripheral device by a portable terminal according to an embodiment of the present invention.

### DETAILED DESCRIPTION

Hereinafter, exemplary embodiments of the present invention will be described in detail with reference to the accompanying drawings. The following description includes specific details, which are only provided to help a more general understanding of the present invention. Therefore, it will be apparent to a person having ordinary knowledge in the technical field of the present invention that predetermined variations and modifications may be made in the specific details without departing from the scope of the present invention.

The present invention is intended to provide a technology, in which when receiving a request for searching for a Bluetooth device, the portable terminal capable of Bluetooth communication acquires location information on Bluetooth devices located around it, calculates relative locations of the Bluetooth devices using the portable terminal as reference and then displays the calculated relative locations of the Bluetooth devices through a GUI. As such, a user is able to intuitively ascertain the actual locations of the Bluetooth devices which are distributedly nearby within a short distance of each other, thus improving the user's convenience.

It should be noted that a portable terminal according to an embodiment of the present invention may perform Bluetooth communication, and may be applied to all types of information communication devices and all types of multimedia devices having a GPS (Global Positioning System) and a compass, including a digital broadcasting terminal, a PDA (Personal Digital Assistant), a smart phone, and 3G (third generation) terminals, for example, an IMT-2000 (International Mobile Telecommunication 2000) terminal, a WCDMA (Wideband Code Division Multiple Access) terminal, a GSM/GPRS (Global System for Mobile Communications/General Packet Radio Service) terminal, and a UMTS (Universal Mobile Telecommunication Service) terminal, etc. and may be applied to the applications of all types of the information communication devices and all types of the multimedia devices.

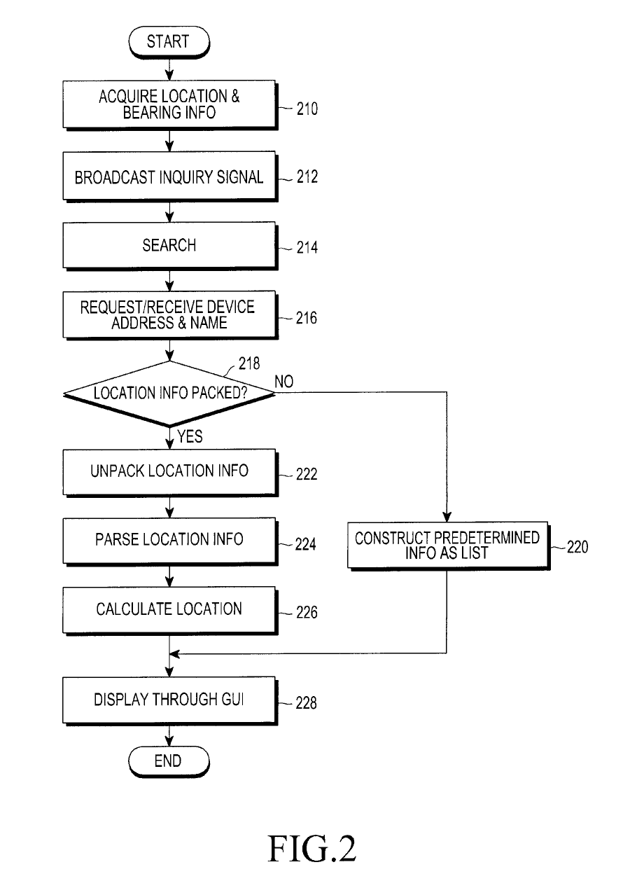

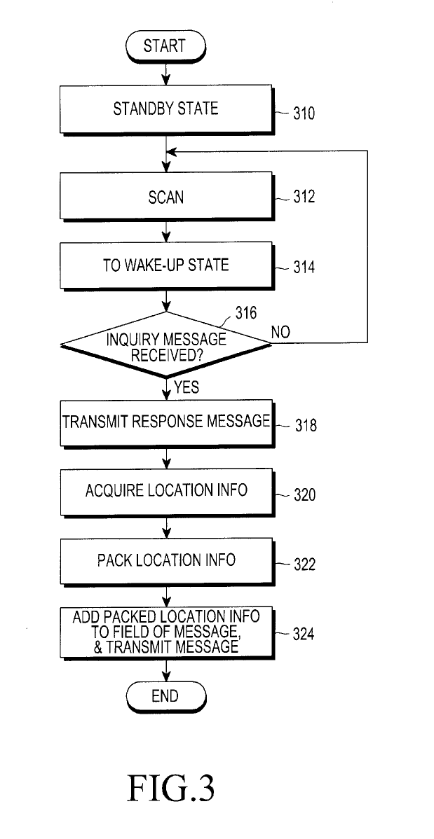

Hereinafter, a method for searching for a Bluetooth device in a portable terminal according to an embodiment of the present invention will be described in detail with reference to FIGS. 2 and 3.

FIG. 2 is a flowchart showing a method for searching for a Bluetooth device in a portable terminal according to an embodiment of the present invention.

First, in step 210, location information and bearing information on the portable terminal are acquired by using a GPS and a compass included in the portable terminal. One skilled in the art would readily appreciate that acquisition of these information is well known in the art. Then, if a request for searching for a Bluetooth device is input, an inquiry signal is broadcasted in step 212 using frequency hopping protocol using predetermined wireless frequency channels for Bluetooth communication.

In step 214, a search is made for Bluetooth devices located around the portable terminal. In step 216, the searched Bluetooth devices are requested for identification information, and then the identification information is acquired. Specifically, each of the Bluetooth devices located around the portable terminal scans the inquiry signal broadcasted by the portable terminal, and is then synchronized with the frequency of the inquiry signal. Then, by transmitting identification information, which includes a Bluetooth device name, a Bluetooth Device Address (BD-ADDR) and clock information, to the portable terminal, each of the searched Bluetooth devices is recognized as a Bluetooth device capable of communication.

The identification information includes name and address information, device information, and location information on the Bluetooth devices located around the portable terminal.

Then, in step 218, a determination is made on whether location information on each of the searched Bluetooth devices is packed in the identification information acquired from the searched Bluetooth devices. When a result of the determination in step 218 shows that the location information is packed in the acquired identification information, the process proceeds to step 222. In step 222, the packed location information is unpacked from the acquired identification information, and the process proceeds to step 224. In step 224, the location information is parsed. At this time, if a preset value, which indicates that a device name of the identification information includes the location information, is ascertained in the process of parsing the location information, the device name and the location information are separated from each other, and then the separated device name and location information are parsed.

Then, in step 226, a relative location of the parsed location information is calculated based on the location information and the bearing information acquired in step 210 and the location information acquired in steps 222 and 224.

Then, in step 228, the calculated relative location is displayed through a Graphical User Interface (GUI) by a display unit of the portable terminal.

On the other hand, when the result of the determination in step 218 shows that the location information is not packed in the acquired identification information, predetermined information included in the acquired identification information is constructed as a list in step 220, and then, the predetermined information constructed as the list is separately displayed by the display unit of the portable terminal in step 228.

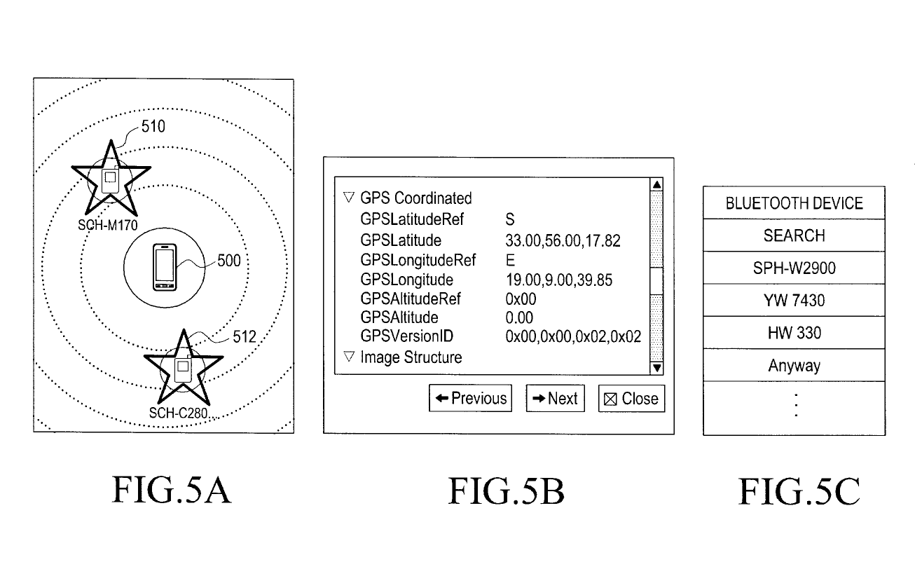

The above operation in steps 210 to 228 will be explained in visually with reference to FIGS. 5A, 5B and 5C hereinafter. FIGS. 5A, 5B and 5C are illustrative views showing screen images related to searching for a peripheral device by the portable terminal according to an embodiment of the present invention.

FIG. 5A illustrates a GUI related to searching for a peripheral device, which the display unit of the portable terminal displays by a request for searching for a Bluetooth device, and shows Bluetooth devices 510 and 512 located around the portable terminal 500 together with their device names. At this time, if a selection is made on any of the surrounding Bluetooth devices displayed by the display unit, location information on the selected Bluetooth device is displayed in a popup form in a predetermined area of the display unit, as illustrated in FIG. 5B. Also, a list in the form as illustrated in FIG. 5C is separately displayed in a predetermined area of the display unit. FIG. 5C illustrates the list constructed from the predetermined information included in the identification information acquired from the surrounding Bluetooth devices capable of the Bluetooth communication when the location information each of the surrounding Bluetooth devices is not packed in the identification information.

Next, an operation performed by a Bluetooth device located around the portable terminal according to an embodiment of the present invention will be described in detail with reference to FIG. 3.

First, the Bluetooth device, which has been in a standby state in step 310, scans predetermined channels (step 312), and through the process of the scan in step 312, is changed to a wake-up state in step 314. In step 316, the Bluetooth device determines whether it has received an inquiry message for searching for a Bluetooth device from a device capable of Bluetooth communication. If so , the process proceeds to step 320. In step 320, the Bluetooth device acquires location information on itself through a GPS.

In step 322, the Bluetooth device packs the acquired location information in device identification information. Then, in step 324, the Bluetooth device adds the device identification information, in which the acquired location information is packed, to a field of a response message which is a response to the inquiry message, and then transmits the response message containing the device identification information to the portable terminal.

When the location information is packed in the device identification information in step 322, a device name of the Bluetooth device is generated in a preset form.

Specifically, the Bluetooth device adds the device identification information having the packed location information to the field of the response message in such a manner as to first express a marker value (e.g. @, ̂, ? and [ ]) and then the location information after the name of the Bluetooth device (e.g. in a Bluetooth device named Apple→Apple@̂49283943_{—}39592343). Therefore, when transmitting the response message, the Bluetooth device first expresses the marker value and then the location information after the device name, without adding a separate field, and then transmits the response message constructed as above to the portable terminal. By doing this, the information packed in the field of the response message, such as Apple@̂49283943_{—}39592343, may be recognized as the device name only.

Meanwhile, when receiving the device name, after which the marker value is expressed, and then ascertaining that the marker value exists in a preset value indicating that the device name includes the location information, the portable terminal separates the device name and the location information from each other, and then parses the separated device name and location information. By doing this, the portable terminal may determine the location information.

As described above, the description has been made of the method for searching for a Bluetooth device in the portable terminal according to an embodiment of the present invention. Note that the above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

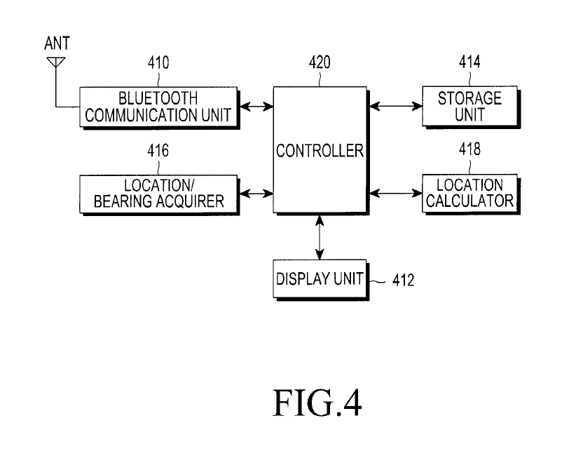

Hereinafter, an apparatus for searching for a Bluetooth device in the portable terminal according to an embodiment of the present invention will be described with reference to FIG. 4.

FIG. 4 is a block diagram illustrating the configuration of an apparatus for searching for a Bluetooth device in a portable terminal according to an embodiment of the present invention.

Referring to FIG. 4, an apparatus for searching for a Bluetooth device in the portable terminal includes a Bluetooth communication unit 410, a display unit 412, a storage unit 414, a location/bearing acquirer 416, a location calculator 418, and a controller 420.

The Bluetooth communication unit 410 transmits/receives signals for acquiring identification information on at least one Bluetooth device capable of Bluetooth communication, which is located around the portable terminal, through predetermined channels.

The location/bearing acquirer 416 may be implemented by a GPS capable of acquiring location information and a compass capable of acquiring bearing information, and acquires the location information and the bearing information of the portable terminal through the GPS and the compass.

The location calculator 418 calculates location information and a relative location of the surrounding Bluetooth device, which has been input, based on the location information and the bearing information acquired by the location/bearing acquirer 416.

The display unit 412 displays, through a GUI, a list of the surrounding Bluetooth devices capable of Bluetooth communication, for which the search has been made by the controller 420, and surrounding Bluetooth devices including their location information.

The storage unit 414 may store programs for the processing and the control of the controller 420, and may store the current location information and bearing information on the portable terminal acquired by the location/bearing acquirer 416.

The controller 420 controls the overall operation of the portable terminal. Also, the controller 420 broadcasts an inquiry signal and then searches for Bluetooth devices located around the portable terminal including the controller 420, requests the searched Bluetooth devices for identification information and then acquires the requested identification information, determines whether location information is packed in the acquired identification information, and calculates a relative location based on the acquired location information and bearing information and then displays the calculated relative location.

According to the above present invention, when receiving a request for searching for a Bluetooth device, the portable terminal capable of Bluetooth communication acquires location information on Bluetooth devices located around it, calculates relative locations of the Bluetooth devices with respect to the portable terminal as the reference and then displays the calculated relative locations of the Bluetooth devices through a GUI.

The configuration and the operation as described above may be implemented in the method and the apparatus for searching for a Bluetooth device in the portable terminal according to the exemplary embodiments of the present invention. Meanwhile, while the specific embodiments have been shown and described in the detailed descriptions of the present invention, it will be understood by those skilled in the art that various changes in form and details may be made therein without departing from the spirit and scope of the invention. Therefore, the spirit and scope of the present invention must be defined not by the described embodiments thereof but by the appended claims and equivalents of the appended claims.

What is claimed is:

1. A method for searching for a Bluetooth device in a portable terminal, the method comprising:
after acquiring location information and bearing information of the portable terminal, broadcasting an inquiry signal to search for Bluetooth devices located around the portable terminal, the inquiry signal requesting the searched Bluetooth devices for identification information;
upon receiving the identification information, determining whether location information on each of the searched Bluetooth devices is packed in the identification information of the searched Bluetooth devices; and
upon receiving the location information from the searched Bluetooth devices is packed, calculating a relative location of the searched Bluetooth devices with respect to the portable terminal based on the acquired location information and bearing information for display.

2. The method as claimed in claim 1, further comprising:
in response to the inquiry signal, acquiring the location information on each of the Bluetooth devices through a GPS (Global Positioning System);
packing the acquired location information in a device identification information by each of the Bluetooth devices; and
adding the device identification information on each of the Bluetooth devices, to a field of a response message responsive to the inquiry signal and then transmitting the response message by each of the Bluetooth devices to the portable terminal.

3. The method as claimed in claim 1, wherein the identification information includes name and address information, device information, and location information on the Bluetooth devices located around the portable terminal.

4. The method as claimed in claim 1, wherein the location information and the bearing information are acquired through a GPS and a compass, respectively.

5. The method as claimed in claim 1, further comprising unpacking the location information and then parsing the location information when the location information is packed in the acquired identification information.

6. The method as claimed in claim 1, further comprising:
when the location information is not packed in the acquired identification information, constructing predetermined information included in the identification information as a list and then separately displaying the predetermined information constructed as the list.

7. The method as claimed in claim 2, wherein, in packing the acquired location information in the device identification information, a device name is generated in a preset form.

8. The method as claimed in claim 5, wherein, in parsing the location information, when a preset value, which indicates that the device name includes the location information, is ascertained, the device name and the location information are separated from each other, and then the separated device name and location information are parsed.

9. An apparatus for searching for a Bluetooth device in a portable terminal, comprising:
a Bluetooth communication unit for transmitting/receiving signals for acquiring identification information on at least one Bluetooth device capable of Bluetooth communication located around the portable terminal;
a location/bearing acquirer for acquiring location information and bearing information of the portable terminal;
a location calculator for calculating a relative location of the at least one Bluetooth device with respect to the portable terminal; and
a controller for broadcasting an inquiry signal and then searching for Bluetooth devices located around the portable terminal, requesting the searched Bluetooth devices for identification information and then acquiring the identification information, determining whether location information of the Bluetooth devices is packed in the acquired identification information, and calculating the relative location between the portable terminal and respective Bluetooth devices based on the location information and the bearing information acquired by the location/bearing acquirer when the location information is packed for display.

10. The apparatus as claimed in claim 9, wherein the location information and the bearing information of the portable terminal are acquired through a GPS (Global Positioning System) and a compass, respectively.

11. The apparatus as claimed in claim 9, wherein the location information of the Bluetooth devices is obtained via a GPS (Global Positioning System).

12. The apparatus as claimed in claim 9, wherein the identification information includes name and address information, device information, and location information on the Bluetooth devices located around the portable terminal.

13. The apparatus as claimed in claim 12, wherein when a preset value, which indicates that the device name includes the location information, is ascertained, the device name and the location information are separated from each other, and then the separated device name and location information are parsed.
